(19) United States
(12) Patent Application Publication
(10) Pub. No.: US 2010/0187149 A1
(43) Pub. Date: Jul. 29, 2010

(54) PACKAGING DEVICE, CUSHIONING MEMBER USED FOR THE SAME, AND METHOD OF MANUFACTURING CUSHIONING MEMBER

(76) Inventors: Katsumi Tsukii, Tokyo (JP); Mitsue Uchida, Tokyo (JP); Hiroyuki Katou, Kanagawa (JP)

Correspondence Address: Mr. Jackson Chen, 6535 N. STATE HWY 161, IRVING, TX, 75039, US

(21) Appl. No.: 12/663,740

(22) PCT Filed: Jun. 10, 2008
(86) PCT No.: PCT/JP2008/060597

§ 371 Date: Dec. 9, 2009

(30) Foreign Application Priority Data
Jun. 13, 2007 (JP) 2007-155942

(51) Int. Cl. B65D 81/02; B31B 1/26

(52) U.S. Cl. 206/521; 493/405

(57) ABSTRACT

A packaging device has a packaging box (12) formed by using a corrugated cardboard sheet and also has a first cushioning member (14) and a second cushioning member (16) that hold an object (W) in the packaging box (12). Each of the set of the cushioning members (14, 16) is formed by bending a corrugated cardboard sheet and has a holding surface section (40; 50) used to hold the object (W) and also has support surface sections (42a, 42b; 52a, 52b) continuing, at a first pair of opposite sides of the holding surface section (40; 50). The support surface sections (42a, 42b; 52a, 52b) are in surface contact with side faces (22, 24) of the packaging box (12) and tip ends of the support surface sections (42a, 42b; 52a, 52b) are in contact with a bottom face (20) of the packaging box (12).

### TECHNICAL FIELD

The present invention relates to a packaging device or packing device which protects an object to be packaged or packed against a shock, a cushioning member used for the packaging device or packing device, and a method of manufacturing or producing the cushioning member.

### BACKGROUND ART

When electronics devices such as personal computers, displays and printers are packed up by the packing device, a cushioning member made of formed styrol or polystyrene foam is widely used so as to be arranged in a packaging box or packing case constituting the packing device. Polystyrene foam provides a high resistance to shock. However, the problem is that polystyrene foam is difficult to recycle. Moreover, the base material of the packing case is normally, for example, corrugated cardboard, not polystyrene foam. Accordingly, when the opened packing device is recycled or disposed of, polystyrene foam needs to be separated from corrugated cardboard. Therefore, in terms of environmental conservation and recycling of resources, it is desirable that the cushioning member made of polystyrene foam should not be used as much as possible.

In recent years, various cushioning members that use no polystyrene foam have therefore been proposed. For example, the cushioning members formed by corrugated cardboard have been proposed (PTL 1 and PTL 2, for example). The cushioning members disclosed in the literature are produced from corrugated cardboard, the same material as that of the packing case. Therefore, no separation is necessary to recycle or dispose of the used packing device. Furthermore, since the material of both the packing case and the cushioning member is corrugated cardboard, the packing case and the cushioning member can be recycled in the same process and therefore have less impact on the environment.

### {Citation List}

### {Patent Literature}

{PTL 1} JP-A-2000-128248
{PTL 2} JP-A-2001-171780

### SUMMARY OF INVENTION

### Technical Problem

FIG. 5 is a developed or unfolded view of the cushioning member disclosed in PTL 1. The base material of the cushioning member is corrugated cardboard. The cushioning member is basically produced through steps such as folding the corrugated cardboard. However, as illustrated in FIG. 5, regarding the cushioning member, the shape in which the corrugated cardboard is cut and the way the corrugated cardboard is folded are complex, requiring enormous efforts and costs in designing and manufacturing. Moreover, since the cushioning member is designed to support one side of an object to be packed, packing requires at least two cushioning members and another cushioning member on the surface opposite to the surface supported by the cushioning member. Therefore, the disadvantage is that the number of cushioning members increases in the packing device that uses the cushioning members.

FIG. 6 is a perspective view of a packing device that uses a cushioning member disclosed in PTL 2. The base material of the cushioning member is, too, corrugated cardboard. The cushioning member is basically produced through steps such as folding the corrugated cardboard. The cushioning member is equipped with a holding section 1 on which an object W that is to be packed is placed. Both ends of the holding section 1 are supported by leg sections 2 each having a V-shaped cross-section. The leg sections 2 are produced through operations, such as cutting, folding and inserting, on the corrugated cardboard sheet on which the holding section 1 is formed. Therefore, forming the leg sections 2 is significantly difficult, the leg sections 2 is large in size, and it is difficult to reduce the costs of materials. Moreover, a space is necessary between the leg sections 2 and the inner wall of a case that houses the leg sections 2; it is difficult to reduce the dimensions of the case with respect to the object W. Even in this respect, it is difficult to reduce the costs of materials.

The present invention has been made to solve the above problems. The objective of the present invention is to provide a packaging device or packing device and a cushioning member that can be produced easily, reduce the amount of materials to be used to reduce the costs of materials, and be easily disposed of and recycled, having less impact on the environment. Another objective of the present invention is to provide a method for manufacturing or producing the above cushioning member.

### Solution to Problem

According to the present invention, in order to achieve one of the objectives, there is provided a packaging device or packing device comprising:

a packaging box or packing case formed by a sheet member; and
a pair of cushioning members that hold in the packing case an object to be packed,
wherein a pair of the cushioning members are each formed by folding a sheet member which is the same as or similar to that of the packing case and each include a holding surface section or holding plane section that is used to hold the object to be packed and support surface sections or supporting plane sections that are seamlessly connected to the holding plane section at facing sides constituting a first pair on the holding plane section, and the supporting plane sections are disposed inside the packing case such that the supporting plane sections are in surface contact with a first inner surface of the packing case.

According to one aspect of the present invention, on a pair of the cushioning members, the top end sections of the supporting plane sections are in contact with a second inner surface of the packing case that is at right angles to the first inner surface of the packing case. According to one aspect of the present invention, on a pair of the cushioning members, the supporting plane sections maintain a pressing force against the first inner surface of the packing case.

According to one aspect of the present invention, at least one of the cushioning members in a pair has an object motion control section that is seamlessly connected to the holding plane section at least one of facing sides constituting a second pair on the holding plane section, and the object motion control section is positioned on the opposite side of the holding plane section to the supporting plane sections and is formed by folding the sheet member plural times. According to one aspect of the present invention, an insertion section into which a projecting section formed on the object to be packed is inserted is formed on the object motion control section.

According to one aspect of the present invention, the sheet member of the packing case and the sheet member of the cushioning members are corrugated cardboard. According to one aspect of the present invention, the direction of the facing sides constituting the first pair on the holding plane section is at right angles to the direction of the corrugation or grain or structure of the corrugated cardboard.

Moreover, according to the present invention, in order to achieve one of the objectives, there is provided a cushioning member that is configured to be disposed inside the packing case,

wherein the cushioning member is formed by folding a sheet member, and includes a holding plane section that is used to hold an object to be packed in the packing case and supporting plane sections that are seamlessly connected to the holding plane section at facing sides constituting a first pair on the holding plane section, and
wherein the supporting plane sections are folded at a right angle to the holding plane section.

According to one aspect of the present invention, the supporting plane section has a restoring force that allows the supporting plane section to go beyond a position where the supporting plane section is perpendicular to the holding plane section and reach a position where the angle of the supporting plane section with respect to the holding plane section is obtuse.

According to one aspect of the present invention, the cushioning member has an object motion control section that is seamlessly connected to the holding plane section at least one of facing sides constituting a second pair on the holding plane section, and the object motion control section is positioned on the opposite side of the holding plane section to the supporting plane sections and is formed by folding the sheet member plural times. According to one aspect of the present invention, an insertion section into which a projecting section formed on the object to be packed is inserted is formed on the object motion control section.

According to one aspect of the present invention, the sheet member is corrugated cardboard. According to one aspect of the present invention, the direction of the facing sides constituting the first pair on the holding plane section is at right angles to the direction of the corrugation or grain or structure of the corrugated cardboard.

According to the present invention, in order to achieve one of the objectives, there is provided a method of manufacturing or producing the above-mentioned cushioning member, including:

a first step of putting a first crease in the sheet member to form a holding plane section area corresponding to the holding plane section and a supporting plane section area corresponding to the supporting plane section, the holding plane section area and the supporting plane section area being divided by the first crease; and
a second step of folding the supporting plane section area at the first crease at a right angle to the holding plane section area to form the holding plane section and the supporting plane section.

According to one aspect of the present invention, at the second step, the supporting plane section area is so folded as to maintain a restoring force that allows the supporting plane section area to go beyond a position where the supporting plane section area is perpendicular to the holding plane section area and reach a position where the angle of the supporting plane section area with respect to the holding plane section area is obtuse.

According to one aspect of the present invention, at the first step, a plurality of second creases parallel to each other are also put in the sheet member to form an object motion control section area that is separated from the holding plane section area by the closest second crease to the holding plane section area; and the method of producing the cushioning member further comprises a third step, at which the object motion control section area is folded plural times at a plurality of the second creases in the direction opposite to that of the supporting plane section area to form an object motion control section. According to one aspect of the present invention, the method of producing the cushioning member further comprises a fourth step of forming on the object motion control section an insertion section into which a projecting section formed on the object to be packed is inserted.

According to one aspect of the present invention, corrugated cardboard is used as the sheet member. According to one aspect of the present invention, at the first step, the first creases are put in the sheet member so that the direction of the first creases is at right angles to the direction of the corrugation or grain or structure of the corrugated cardboard.

### ADVANTAGEOUS EFFECTS OF INVENTION

In the packing device of the present invention, the entire packing case and cushioning members are made of the same or similar sheet member such as corrugated cardboard sheet. Therefore, the packing device can be easily recycled and disposed of, having less impact on the environment. Moreover, the cushioning members that constitute the packing device of the present invention have the supporting plane section that is connected to the holding plane section at each of the facing sides constituting the first pair on the holding plane section used to hold the object to be packed, and the supporting plane section is disposed inside the packing case such that the supporting plane section is in surface contact with the first inner surface of the packing case, thereby leading to an increase in the strength of supporting by the supporting plane sections and of the portions around the facing sides constituting the first pair. Therefore, the object to be packed can be resiliently or elastically supported. That is, even if a strong shock is applied to the holding plane sections, the holding plane sections continue to deform elastically without falling into plastic deformation. Therefore, the object to be packed does not break down because the object to be packed does not slip off the support provided by the holding plane sections. Moreover, according to the cushioning members, the supporting plane sections can be downsized. Furthermore, the packing case can be downsized. Therefore, the amount of materials to be used decreases, leading to a reduction in the costs of materials for the cushioning members and the packing device. Furthermore, the cushioning members can be easily made or produced or manufactured.

### BRIEF DESCRIPTION OF DRAWINGS

FIG. 1 An exploded perspective view illustrating the configuration of a packing device according to a first embodiment of the present invention.

FIG. 2A A perspective view illustrating the production process of a first cushioning member.

FIG. 2B A perspective view illustrating the production process of the first cushioning member.

FIG. 2C A perspective view illustrating the production process of the first cushioning member.

FIG. 3A A perspective view illustrating the production process of a second cushioning member.

FIG. 3B A perspective view illustrating the production process of the second cushioning member.

FIG. 3C A perspective view illustrating the production process of the second cushioning member.

FIG. 4 A perspective view illustrating the configuration of a packing device according to a second embodiment of the present invention, with part of the packing device omitted.

FIG. 5 A developed view illustrating an example of a conventional cushioning member.

FIG. 6 A perspective view illustrating an example of a conventional packing device.

### DESCRIPTION OF EMBODIMENTS

FIG. 1 is an exploded perspective view illustrating the configuration of a packing device 10 according to an embodiment of the present invention. The packing device 10 is equipped with a packing case 12, a first cushioning member 14 and a second cushioning member 16, which are each formed by a sheet member. The first cushioning member 14 and the second cushioning member 16 constitute a pair of cushioning members, are disposed in the packing case 12, and hold an object W that is to be packed therebetween in the vertical direction (a direction indicated by an arrow X1-X2 in FIG. 1). The packing case 12, the first cushioning member 14 and the second cushioning member 16 are formed by the same or similar resilient sheet members, such as recyclable corrugated cardboard. The “similar” sheet members mean that the sheet members are made of the same material such as corrugated cardboard while the differences in thickness, quality and the like are allowed. In the present embodiment, the following describes the sheet members made of corrugated cardboard.

The packing case 12 is equipped with a bottom faces or bottom plane portion 20, side faces or side plane portions 22, 24, 26 and 28, and a ceiling face or ceiling plane portion 30. The ceiling plane portion 30 includes ceiling flaps 30a, 30b, 30c and 30d that can be opened and closed.

The first cushioning member 14 is formed from one sheet of corrugated cardboard. The first cushioning member 14 is equipped with a holding plane section 40, which serves as a stage on which the object W to be packed is placed, supporting plane sections 42a and 42b, and object motion control sections (hereinafter simply referred to as “control sections”) 44a and 44b.

The holding plane section 40 is where the object W is placed. The holding plane section 40 is substantially rectangular in shape and has a first pair of facing sides (a pair of sides that extend in the longer direction indicated by an arrow Y1 and are separated from each other in the shorter direction indicated by an arrow Y2 in FIG. 1) and a second pair of facing sides (a pair of sides that extend in the shorter direction indicated by the arrow Y2 and are separated from each other in the longer direction indicated by the arrow Y1 in FIG. 1). Incidentally, in the diagram, regarding the direction indicated by the arrow X1-X2, the direction indicated by the arrow Y1, and the direction indicated by the arrow Y2, each direction is at right angles to the other two directions. On the holding plane section 40, the direction of the corrugation of the corrugated cardboard sheet (the direction in which the long and narrow hollow sections formed by the corrugated structure of the corrugated cardboard sheet extend) is the direction indicated by the arrow Y2. The corrugated cardboard sheet itself has a relatively high bending elasticity in the direction of the corrugation and a relatively low bending elasticity in a direction that is at right angles to the direction of the corrugation.

The supporting plane sections 42a and 42b are seamlessly connected to the holding plane section 40 at the facing sides that constitute the first pair on the holding plane section 40 and extend in a first direction (indicated by the arrow X1 in FIG. 1) that is at right angles to the holding plane section 40. Regarding the supporting plane sections 42a and 42b, the direction of the corrugation of the corrugated cardboard sheet is the direction indicated by the arrow X1-X2. The supporting plane sections 42a and 42b are in surface contact with the side plane portions 22 and 26, which constitute a first inner surface of the packing case 12, maintaining the pressing force against the side plane portions 22 and 26. The pressing force originates from the bending elasticity of the corrugated cardboard sheet. That is, after the corrugated cardboard sheet is folded to form the holding plane section 40 and the supporting plane sections 42a and 42b, the restoring force is maintained so that the supporting plane sections 42a and 42b go beyond positions where the supporting plane sections 42a and 42b are perpendicular to the holding plane section 40 to reach positions where the angle of the supporting plane sections 42a and 42b with respect to the holding plane section 40 is obtuse. Accordingly, when the supporting plane sections 42a and 42b are at positions where the supporting plane sections 42a and 42b are substantially perpendicular to the holding plane section 40, the pressing force against the side plane portions 22 and 26 remains. The tip end sections, or bottom end sections, of the supporting plane sections 42a and 42b are in contact with the bottom plane portion 20 that constitute a second inner surface of the packing case 12. The bottom plane portion 20 is at right angles to the side plane portions 22 and 26, which are the first inner surface of the packing case 12. Therefore, the motion or movement of the first cushioning member 14 including the supporting plane sections 42a and 42b and the holding plane section 40 is limited in the direction indicated by the arrow X1. Since the supporting plane sections 42a and 42b are formed, the bending elasticity of the first cushioning member 14 including the holding plane section 40 rises in a direction that is at right angles to the direction of the corrugation of the corrugated cardboard sheet. Incidentally, the supporting plane sections 42a and 42b may be bonded to the side plane portions 22 and 26 with a gluing agent or adhesive.

The control sections 44a and 44b are formed by folding the corrugated cardboard sheet plural times from the facing sides that constitute the second pair on the holding plane section 40. The direction of folding is opposite to that of the supporting plane sections 42a and 42b. Therefore, the control sections 44a and 44b are members in the shape of an angular tube, project from the holding plane section 40 in the direction indicated by the arrow X2, and extend in the direction indicated by the arrow Y2. The control sections 44a and 44b are separated from each other in the direction indicated by the arrow Y1. That is, the control sections 44a and 44b are seamlessly connected to the holding plane section 40 at the facing sides that constitute the second pair on the holding plane section 40 and are positioned on the opposite side of the holding surface section 40 to the supporting plane sections 42a and 42b.

The control sections 44a and 44b limit the motion or movement of the object W in the direction indicated by the arrow Y1. That is, the distance between the control sections 44a and 44b is slightly wider than the length of the object W in the direction indicated by the arrow Y1. The height of the control sections 44a and 44b is substantially the same as or slightly shorter than the thickness of the object W in the direction indicated by the arrow X1-X2. Incidentally, the control section may be formed at only one of the facing sides that constitute the second pair on the holding plane section 40 such that the control section is seamlessly connected to the holding plane section 40.

The second cushioning member 16 is formed from one sheet of corrugated cardboard. The second cushioning member 16 is equipped with a holding plane section 50, which serves as a pressing/holding surface, and supporting plane sections 52a and 52b.

The holding plane section 50 is a portion that presses or pushes the object W in the downward direction indicated by the arrow X1 in FIG. 1 and holds the object W. Like the holding plane section 40, the holding plane section 50 is substantially rectangular in shape and has a first pair of facing sides (a pair of sides that extend in the longer direction indicated by an arrow Y1 and are separated from each other in the shorter direction indicated by an arrow Y2 in FIG. 1) and a second pair of facing sides (a pair of sides that extend in the shorter direction indicated by the arrow Y2 and are separated from each other in the longer direction indicated by the arrow Y1 in FIG. 1). On the holding plane section 50, the direction of the corrugation of the corrugated cardboard sheet is the direction indicated by the arrow Y2.

The supporting plane sections 52a and 52b are seamlessly connected to the holding plane section 50 at the facing sides that constitute the first pair on the holding plane section 50 and extend in a second direction (indicated by the arrow X2 in FIG. 1) that is at right angles to the holding plane section 50. Regarding the supporting plane sections 52a and 52b, the direction of the corrugation of the corrugated cardboard sheet is the direction indicated by the arrow X1-X2. Like the supporting plane sections 42a and 42b of the first cushioning member 14, the supporting plane sections 52a and 52b are in surface contact with the side plane portions 22 and 26, which are the first inner surface of the packing case 12, maintaining the pressing force against the side plane portions 22 and 26. The pressing force originates from the bending elasticity of the corrugated cardboard sheet. That is, after the corrugated cardboard sheet is folded to form the holding plane section 50 and the supporting plane sections 52a and 52b, the restoring force is maintained so that the supporting plane sections 52a and 52b go beyond positions where the supporting plane sections 52a and 52b are perpendicular to the holding plane section 50 to reach positions where the angle of the supporting plane sections 52a and 52b with respect to the holding plane section 50 is obtuse. Accordingly, when the supporting plane sections 52a and 52b are at positions where the supporting plane sections 52a and 52b are substantially perpendicular to the holding plane section 50, the pressing force against the side plane portions 22 and 26 remains.

The tip end sections, or upper end sections, of the supporting plane sections 52a and 52b are folded inward to form contact plane sections 54a and 54b. The contact plane sections 54a and 54b are in contact with the ceiling plane portion 30 that constitutes a third inner surface of the packing case 12. The ceiling plane portion 30 is at right angles to the side plane portions 22 and 26, which are the first inner surface of the packing case 12. Therefore, the motion or movement of the second cushioning member 16 including the supporting plane sections 52a and 52b and the holding plane section 50 is limited in the direction indicated by the arrow X2. Since the supporting plane sections 52a and 52b are formed, the bending elasticity of the second cushioning member 16 including the holding plane section 50 rises in a direction that is at right angles to the direction of the corrugation of the corrugated cardboard sheet.

Therefore, in the packing case 12, the object W is held by a pair of cushioning members, which are the first cushioning member 14 and the second cushioning member 16. The object W is held because the holding plane section 40 of the first cushioning member 14 and the holding plane section 50 of the second cushioning member 16 apply, based on the downward pressing force that the ceiling plane portion 30 of the packing case 12 applies to the contact plane sections 54a and 54 of the second cushioning member 16, a compressive force originating from bending elasticity to the object W.

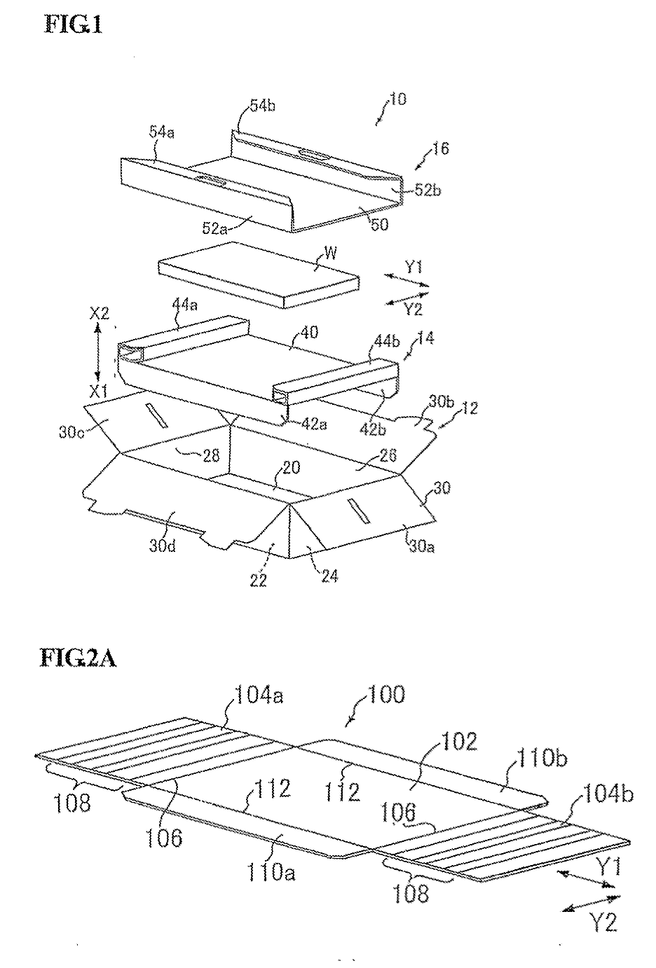

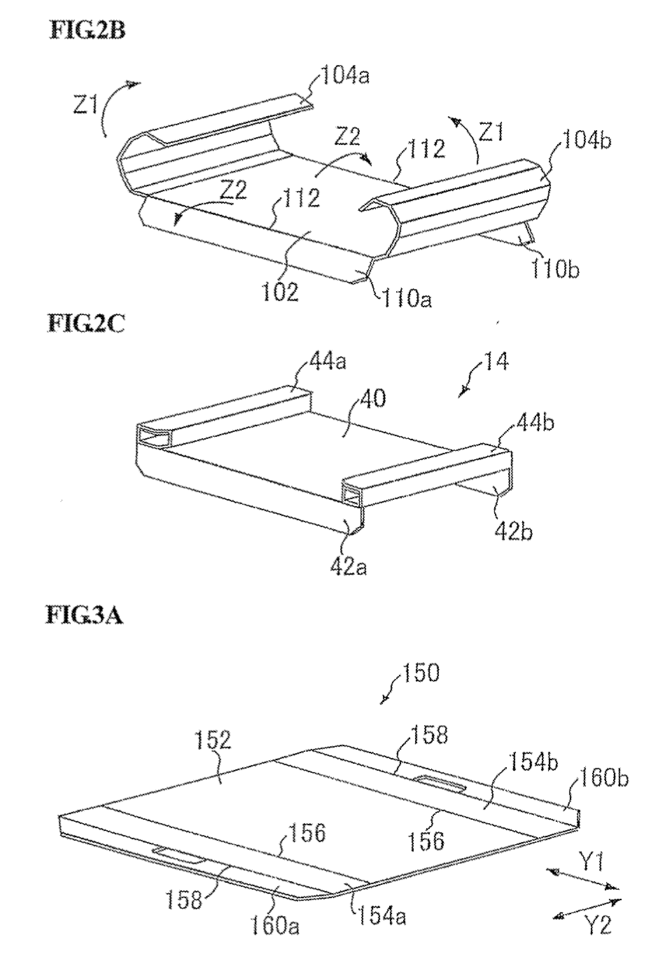

FIGS. 2A, 2B and 2C are perspective views illustrating the production process of the first cushioning member 14. As illustrated in FIG. 2A, the base material of the first cushioning member 14 to be formed is one corrugated cardboard sheet 100, which is substantially rectangular in shape. The corrugated cardboard sheet 100 is for example cut out by an appropriate die-cutting device.

First, as illustrated in FIG. 2A, a holding plane section area 102 that corresponds to the holding plane section 40 of the manufactured product is formed around the center of the corrugated cardboard sheet 100. At both ends of the longer sides (which extend in the direction indicated by the arrow Y1 in FIG. 2A) of the corrugated cardboard sheet 100, object motion control section areas (hereinafter simply referred to as “control section areas”) 104a and 104b are formed as first flap sections such that the control section areas 104a and 104b are seamlessly connected to the holding plane section area 102. The control section areas 104a and 104b correspond to the control sections 44a and 44b of the manufactured product. The holding plane section area 102 and the control section areas 104a and 104b are divided by creases 106. Moreover, a plurality of creases 108 are formed on the control section areas 104a and 104b, extending substantially parallel to the creases 106. At both ends of the shorter sides (which extend in the direction indicated by the arrow Y2 in FIG. 2A) of the corrugated cardboard sheet 100, supporting plane section areas 110a and 110b are formed as second flap sections such that the supporting plane section areas 110a and 110b are seamlessly connected to the holding plane section area 102. The supporting plane section areas 110a and 110b correspond to the supporting plane sections 42a and 42b of the manufactured product. The holding plane section area 102 and the supporting plane section areas 110a and 110b are divided by creases 112. Accordingly, after the first creases 112 are put in the corrugated cardboard sheet 100, a first step of forming the holding plane section area 102 and the supporting plane section areas 110a and 110b, which are divided by the creases 112, is completed. According to the present embodiment, at the first step, a plurality of second creases 106 and 108 that are parallel to each other are also put in the corrugated cardboard sheet 100, forming the control section areas 104a and 104b separated from the holding plane section area 102 by the crease 106 that is the closest to the holding plane section area 102 of the second creases 106 and 108.

Then, as illustrated in FIG. 2B, with the creases 112 as axes, the supporting plane section areas 110a and 110b are folded downward and inward (in the direction indicated by an arrow Z2 in FIG. 2B) to form substantially a right angle between the holding plane section area 102 and the supporting plane section areas 110a and 110b. Then, as illustrated in FIG. 2B, the control section areas 104a and 104b are folded upward and inward (in the direction indicated by an arrow Z1 in FIG. 2B) plural times from the outside toward the inside at a plurality of creases 108 and the creases 106 with each of the creases sequentially serving as an axis, so that the control section areas 104a and 104b are rolled.

In that manner, after the supporting plane section areas 110a and 110b are folded at the first creases 112 at a right angle to the holding plane section area 102, a second step of forming the holding plane section 40 and the supporting plane sections 42a and 42b is completed as illustrated in FIG. 2C. Moreover, after the control section areas 104a and 104b are folded plural times at a plurality of second creases 106 and 108 in the direction opposite to that of the supporting plane section areas 110a and 110b, a third step of forming the control sections 44a and 44b is completed as illustrated in FIG. 2C. Incidentally, the above third step may be performed prior to the above second step.

As a result of going through the above production process, the first cushioning member 14 illustrated in FIG. 2C, i.e., the first cushioning member 14 used in the packing device 10 illustrated in FIG. 1, is produced.

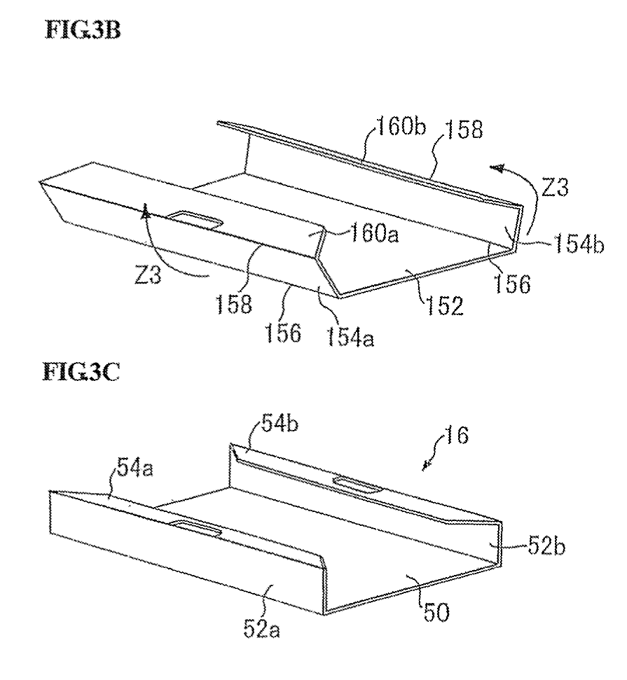

FIGS. 3A, 3B and 3C are perspective views illustrating the production process of the second cushioning member 16. As illustrated in FIG. 3A, the base material of the second cushioning member 16 to be formed is one corrugated cardboard sheet 150, which is substantially rectangular in shape. The corrugated cardboard sheet 150 is for example cut out by an appropriate die-cutting device.

First, as illustrated in FIG. 3A, a holding plane section area 152 that corresponds to the holding plane section 50 of the manufactured product is formed around the center of the corrugated cardboard sheet 150. At both ends of the shorter sides (which extend in the direction indicated by the arrow Y2 in FIG. 3A) of the corrugated cardboard sheet 150, supporting plane section areas 154a and 154b are formed as third flap sections such that the supporting plane section areas 154a and 154b are seamlessly connected to the holding plane section area 152. The supporting plane section areas 154a and 154b correspond to the supporting plane sections 52a and 52b of the manufactured product. The holding plane section area 152 and the supporting plane section areas 154a and 154b are divided by creases 156. Moreover, at the tip ends of the supporting plane section areas 154a and 154b, contact plane section areas 160a and 160b are formed as fourth flap sections through creases 158. The contact plane section areas 160a and 160b correspond to the contact plane sections 54a and 54b of the manufactured product. Accordingly, after the first creases 156 are put in the corrugated cardboard sheet 150, a first step of forming the holding plane section area 152 and the supporting plane section areas 154a and 154b is completed. Therefore, after the first creases 156 are put in the corrugated cardboard sheet 150, a first step of forming the holding plane section area 152 and the supporting plane section areas 154a and 154b, which are divided by the creases 156, is completed. According to the present embodiment, at the first step, the creases 158 that are parallel to the creases 156 are also put in the corrugated cardboard sheet 150, forming the contact plane section areas 160a and 160b.

Then, as illustrated in FIG. 3B, with the creases 156 as axes, the supporting plane section areas 154a and 154b are folded upward and inward (in the direction indicated by an arrow Z3 in FIG. 3B) to form substantially a right angle between the holding plane section area 152 and the supporting plane section areas 154a and 154b. Then, as illustrated in FIG. 3B, with the creases 158 as axes, the contact plane section areas 160a and 160b are folded inward (in the direction indicated by the arrow Z3 in FIG. 3B) to form substantially a right angle between the supporting plane section areas 154a and 154b and the contact plane section areas 160a and 160b, respectively.

In that manner, after the supporting plane section areas 154a and 154b are folded at the first creases 156 at a right angle to the holding plane section area 152, a second step of forming the holding plane section 50 and the supporting plane sections 52a and 52b is completed as illustrated in FIG. 3C.

As a result of going through the above production process, the second cushioning member 16 illustrated in FIG. 3C, i.e., the second cushioning member 16 used in the packing device 10 illustrated in FIG. 1, is produced.

As described above, according to the embodiment of the present invention, all the components (i.e., the packing case 12, the first cushioning member 14 and the second cushioning member 16) of the packing device 10 are made of the same or similar recyclable material such as corrugated cardboard. Therefore, the packing device 10 can be easily recycled and disposed of, having less impact on the environment.

Moreover, the supporting plane sections 42a and 42b are formed by folding the corrugated cardboard sheet 100 at the facing sides that constitute the first pair on the holding plane section 40 of the first cushioning member 14. The supporting plane sections 42a and 42b have a function to support the first cushioning member 14 as well as a function to settle or fix the position of the periphery of the holding plane section 40 to allow elastic deformation of the holding plane section 40. Similarly, the supporting plane sections 52a and 52b are formed by folding the corrugated cardboard sheet 150 at the facing sides that constitute the first pair on the holding plane section 50 of the second cushioning member 16. The supporting plane sections 52a and 52b have a function to support the second cushioning member 16 as well as a function to settle or fix the position of the periphery of the holding plane section 50 to allow elastic deformation of the holding plane section 50. Moreover, the supporting plane sections 42a, 42b, 52a and 52b are disposed to be in surface contact with the inner surface of the packing case, leading to an increase in the strength of supporting by the supporting plane sections 42a, 42b, 52a and 52b and of the portions around the facing sides constituting the first pair. Therefore, the object W can be resiliently supported. That is, even if a strong shock is applied to the holding plane sections 40 and 50, the holding plane sections 40 and 50 continue to deform elastically without falling into plastic deformation. Therefore, the object W does not slip off the support provided by the holding plane sections. Thus, the object W does not break down because the object W does not crash onto surfaces like the bottom plane portion 20 of the packing case 12.

Moreover, according to the first cushioning member 14 and the second cushioning member 16, the supporting plane sections 42a, 42b, 52a and 52b can be downsized. Moreover, the packing case 12 can be downsized because the supporting plane sections 42a, 42b, 52a and 52b are in surface contact with the inner surface of the packing case 12. Therefore, the amount of materials to be used decreases, leading to a reduction in the costs of materials.

Moreover, regarding the first cushioning member 14 and the second cushioning member 16, the shape in which the corrugated cardboard is cut and the way the corrugated cardboard is folded are simple, leading to a reduction in production costs.

Incidentally, in the above embodiment, the facing sides that constitute the first pairs on the holding plane sections 40 and 50 on which the supporting plane sections 42a and 42b of the first cushioning member 14 and the supporting plane sections 52a and 52b of the second cushioning member 16 are formed are the longer sides of the holding plane sections 40 and 50. Alternatively, the facing sides that constitute the first pairs may be the shorter sides of the holding plane sections 40 and 50. Moreover, in the above embodiment, the supporting plane sections 42a and 42b of the first cushioning member 14 are parallel to the supporting plane sections 52a and 52b of the second cushioning member 16. Alternatively, the supporting plane sections 42a and 42b of the first cushioning member 14 may be at right angles to the supporting plane sections 52a and 52b of the second cushioning member 16. Regarding the supporting plane sections 42a and 42b, the supporting plane sections 52a and 52b and the control sections 44a and 44b, each section is not necessarily formed all along the side and may be formed on a portion of the side. Furthermore, in the above embodiment, the control sections 44a and 44b are formed on the first cushioning member 14. Similar control sections may be formed on the second cushioning member 16. The control sections may be formed on both the first cushioning member 14 and the second cushioning member 16. In this case, in order to prevent both ends of the control section of the first cushioning member 14 from overlapping with both ends of the control section of the second cushioning member 16, either the control section of the first cushioning member 14 or the control section of the second cushioning member 16 is formed on a portion of the side.

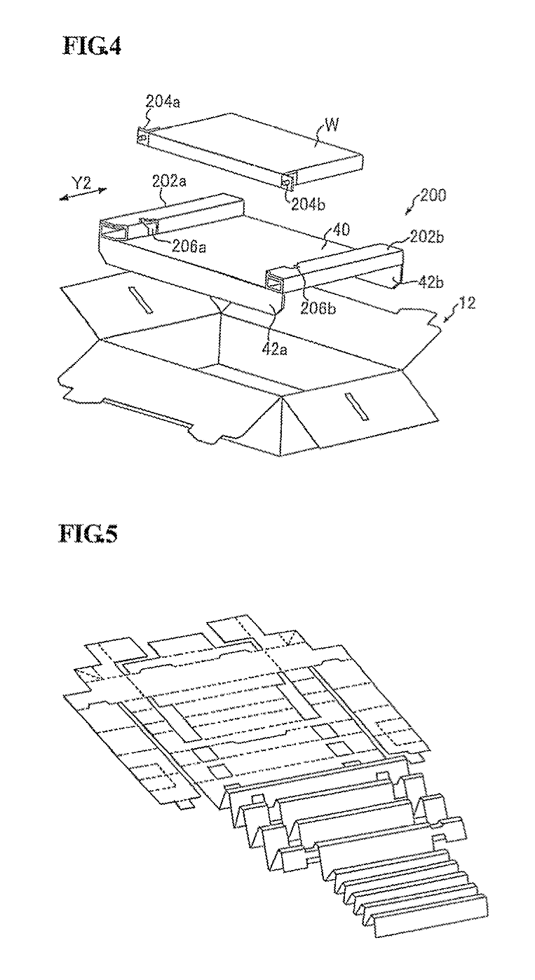

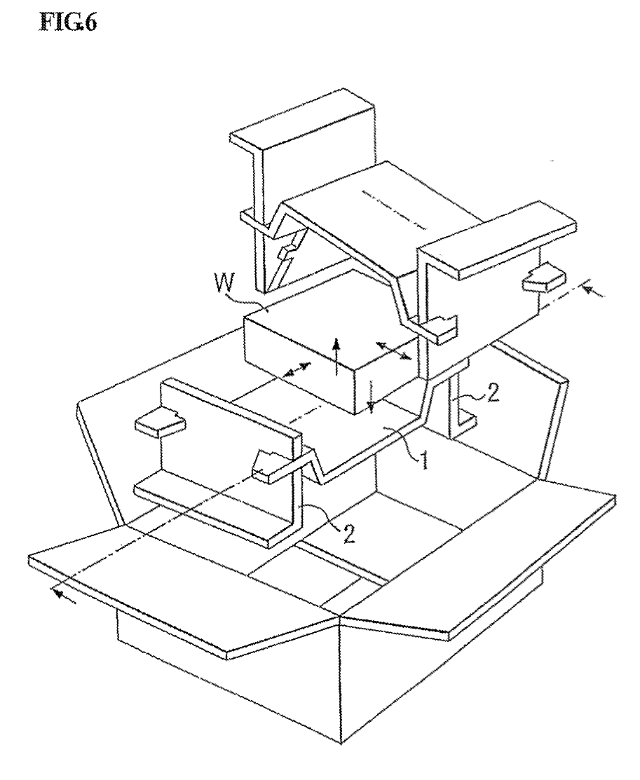

FIG. 4 is a perspective view illustrating the configuration of a packing device according to a second embodiment of the present invention; part of the packing device is omitted in the diagram. In the diagram, the components that have similar functions to those of FIG. 1 have been denoted by the same reference numerals.

The present embodiment is applied to the object W that is equipped with projecting sections 204a and 204b. Insertion sections 206a and 206b into which the projecting sections 204a and 204b formed on the object W are inserted are formed on control sections 202a and 202b of a first cushioning member 200.

When the object W is placed on the holding plane section 40, the projecting sections 204a and 204b of the object W are inserted into the insertion sections 206a and 206b of the control sections 202a and 202b, thereby limiting the motion or movement of the object W in the shorter direction (the direction indicated by an arrow Y2 in FIG. 4) of the holding plane section 40. The shape, size and number of the insertion sections 206a and 206b may vary according to the shape, size and number of the projecting sections 204a and 204b of the object W.

The production method of the first cushioning member 200 may be realized by adding a step of forming the insertion sections 206a and 206b to the production method of the first cushioning member 14 of the first embodiment. That is, a forth step of forming on the control sections 202a and 202b the insertion sections 206a and 206b into which the projecting sections 204a and 204b formed on the object W are inserted is added. At the fourth step of forming the insertion sections 206a and 206b, after the control sections 44a and 44b are formed by folding the control section areas 104a and 104b, which are the first flap sections, as described in the first embodiment, predetermined portions of the control sections may be cut. Alternatively, holes may be made in advance in predetermined portions of the control section areas 104a and 104b which are the first flap sections.

The above has described the present invention with reference to the embodiments. However, the present invention is not limited to the above-described embodiments. It should be understood by those skilled in the art that various modifications may be made in the configuration and details of the present invention insofar as they are within the scope of the present invention.

The present application is based upon and claims the benefit of priority from prior Japanese Patent Application No. 2007-155942, filed with Japan Patent Office on Jun. 13, 2007, the entire contents of which are incorporated herein by reference.

### REFERENCE SIGNS LIST

10: Packing device
12: Packing case
14: First cushioning member
16: Second cushioning member
20: Bottom plane portion
22, 24, 26, 28: Side plane portion
30: Ceiling plane portion
30a, 30b, 30c, 30d: Ceiling flap
40: Holding plane section
42a, 42b: Supporting plane section
44a, 44b: Object motion control section
50: Holding plane section
52a, 52b: Supporting plane section
54a, 54b: Contact plane section
100: Corrugated cardboard sheet
102: Holding plane section area
104a, 104b: Object motion control section area
106, 108, 112: Crease
110a, 110b: Supporting plane section area
150: Corrugated cardboard sheet
152: Holding plane section area
154a, 154b: Supporting plane section area
156, 158: Crease
160a, 160b: Contact plane section area
204a, 204b: Projecting section
206a, 206b: Insertion section
W: Object to be packed

1. A packing device comprising:
a packing case formed by a sheet member; and
a pair of cushioning members that hold in the packing case an object to be packed,
wherein a pair of the cushioning members are each formed by folding a sheet member which is the same as or similar to that of the packing case and each include a holding plane section that is used to hold the object to be packed and supporting plane sections that are connected to the holding plane section at facing sides constituting a first pair on the holding plane section, and the supporting plane sections are disposed inside the packing case such that the supporting plane sections are in surface contact with a first inner surface of the packing case.

2. The packing device according to claim 1, wherein, on a pair of the cushioning members, the top end sections of the supporting plane sections are in contact with a second inner surface of the packing case that is at right angles to the first inner surface of the packing case.

3. The packing device according to claim 1, wherein, on a pair of the cushioning members, the supporting plane sections maintain a pressing force against the first inner surface of the packing case.

4. The packing device according to claim 1, wherein at least one of the cushioning members in a pair has an object motion control section that is connected to the holding plane section at least one of facing sides constituting a second pair on the holding plane section, and the object motion control section is positioned on the opposite side of the holding plane section to the supporting plane sections and is formed by folding the sheet member plural times.

5. The packing device according to claim 4, wherein an insertion section into which a projecting section formed on the object to be packed is inserted is formed on the object motion control section.

6. The packing device according to claim 1, wherein the sheet member of the packing case and the sheet member of the cushioning members are corrugated cardboard.

7. The packing device according to claim 6, wherein the direction of the facing sides constituting the first pair on the holding plane section is at right angles to the direction of corrugation of the corrugated cardboard.

8. A cushioning member that is configured to be disposed inside the packing case,
wherein the cushioning member is formed by folding a sheet member, and includes a holding plane section that is used to hold an object to be packed in the packing case and supporting plane sections that are connected to the holding plane section at facing sides constituting a first pair on the holding plane section, and
wherein the supporting plane sections are folded at a right angle to the holding plane section.

9. The cushioning member according to claim 8, wherein the supporting plane section has a restoring force that allows the supporting plane section to go beyond a position where the supporting plane section is perpendicular to the holding plane section and reach a position where the angle of the supporting plane section with respect to the holding plane section is obtuse.

10. The cushioning member according to claim 8, wherein the cushioning member has an object motion control section that is connected to the holding plane section at least one of facing sides constituting a second pair on the holding plane section, and the object motion control section is positioned on the opposite side of the holding plane section to the supporting plane sections and is formed by folding the sheet member plural times.

11. The cushioning member according to claim 10, wherein an insertion section into which a projecting section formed on the object to be packed is inserted is formed on the object motion control section.

12. The cushioning member according to claim 8, wherein the sheet member is corrugated cardboard.

13. The cushioning member according to claim 12, wherein the direction of the facing sides constituting the first pair on the holding plane section is at right angles to the direction of corrugation of the corrugated cardboard.

14. A method of producing the cushioning member as set forth in claim 8, comprising:
a first step of putting a first crease in the sheet member to form a holding plane section area corresponding to the holding plane section and a supporting plane section area corresponding to the supporting plane section, the holding plane section area and the supporting plane section area being divided by the first crease; and
a second step of folding the supporting plane section area at the first crease at a right angle to the holding plane section area to form the holding plane section and the supporting plane section.

15. The method of producing the cushioning member according to claim 14, wherein, at the second step, the supporting plane section area is so folded as to maintain a restoring force that allows the supporting plane section area to go beyond a position where the supporting plane section area is perpendicular to the holding plane section area and reach a position where the angle of the supporting plane section area with respect to the holding plane section area is obtuse.

16. The method of producing the cushioning member according to claim 14, wherein, at the first step, a plurality of second creases parallel to each other are put in the sheet member to form an object motion control section area that is separated from the holding plane section area by the closest second crease to the holding plane section area; and the method of producing the cushioning member further comprises a third step, at which the object motion control section area is folded plural times at a plurality of the second creases in the direction opposite to that of the supporting plane section area to form an object motion control section.

17. The method of producing the cushioning member according to claim 16, further comprising a fourth step of forming on the object motion control section an insertion section into which a projecting section formed on the object to be packed is inserted.

18. The method of producing the cushioning member according to claim 14, wherein corrugated cardboard is used as the sheet member.

19. The method of producing the cushioning member according to claim 18, wherein, at the first step, the first creases are put in the sheet member so that the direction of the first creases is at right angles to the direction of corrugation of the corrugated cardboard.
